(19) United States
(12) Patent Application Publication
(10) Pub. No.: US 2022/0084437 A1
(43) Pub. Date: Mar. 17, 2022

(54) MOBILE-ENABLED COGNITIVE BRAILLE ADJUSTMENT

(71) Applicant: INTERNATIONAL BUSINESS MACHINES CORPORATION, Armonk, NY (US)

(72) Inventors: Gray Franklin Cannon, Miami, FL (US); Shikhar Kwatra, San Jose, CA (US); Indervir Singh Banipal, Austin, TX (US); Ali Ishaq Unwala, Pflugerville, TX (US)

(21) Appl. No.: 17/024,413

(22) Filed: Sep. 17, 2020

(51) Int. Cl. G09B 21/00; G06F 40/58

(52) U.S. Cl. CPC G09B 21/005; G06F 40/58; G09B 21/007

(57) ABSTRACT

A method, computer system, and computer program product for cognitive braille adjustment is provided. The embodiment may include identifying a language in which text on a document is written. The embodiment may also include generating a natural language understanding dataset of the text. The embodiment may further include performing a translation of the text to braille using the natural language understanding dataset. The embodiment may also include presenting the translation to a user using one or more associated hardware units.

### BACKGROUND

The present invention relates generally to the field of computing, and more particularly to accessibility features.

Accessibility relates to the design of products, devices, services, or environments so as to enable functionality by all individuals. Individuals with certain impairments may require design modifications in order to perform functions or use devices that individuals without such impairments are freely capable of performing. For example, a visually-impaired person may require large print text in order to read documents. Accessibility functions may include adjustments for physical impairment, visual impairment, audio impairment, mental health impairment, intellectual impairment, or learning impairment.

### SUMMARY

According to one embodiment, a method, computer system, and computer program product for cognitive braille adjustment is provided. The embodiment may include identifying a language in which text on a document is written. The embodiment may also include generating a natural language understanding dataset of the text. The embodiment may further include performing a translation of the text to braille using the natural language understanding dataset. The embodiment may also include presenting the translation to a user using one or more associated hardware units.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for cognitive braille adjustment process according to at least one embodiment.

FIG. 3 is a block diagram of internal and external components of computers and servers depicted in FIG. 1 according to at least one embodiment.

FIG. 4 depicts a cloud computing environment according to an embodiment of the present invention.

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to accessibility features. The following described exemplary embodiments provide a system, method, and program product to, among other things, translate written language into braille and present the translated language to a user through a user device. Therefore, the present embodiment has the capacity to improve the technical field of accessibility features by allowing visually-impaired users further accessibility features when interacting with physical mail and media.

As previously described, accessibility relates to the design of products, devices, services, or environments so as to enable functionality by all individuals. Individuals with certain impairments may require design modifications in order to perform functions or use devices that individuals without such impairments are freely capable of performing. For example, a visually-impaired person may require large print text in order to read documents. Accessibility functions may include adjustments for physical impairment, visual impairment, audio impairment, mental health impairment, intellectual impairment, or learning impairment.

Computing has radically transformed the way people communicate, improving both speed and quality of information exchange. In particular, computing enables authentication restrictions, accurate language translation, and personalization in ways that paper communications cannot. However, paper communications remain both prevalent and necessary as direct mail advertising continues to bring in significant revenue for many businesses and many official government communications are transmitted through physical mail.

The use of physical mail is especially disadvantageous for people with visual impairment as they cannot access the accessibility features that are enabled by computing. As such, it may be advantageous to, among other things, utilizing computer vision and natural language understanding technologies to translate physical documents in various languages to braille and then present the braille-translated documents to a user according to user preferences, which can bridge the experience gaps facing individuals with visual impairment when they receive physical mail.

According to at least one embodiment, dynamic haptic feedback may be provided for assisting visually impaired individuals by allowing a user device, such as a smartphone, to capture an image of written text and activating a software-enabled and hardware-enabled embodiment to dynamically translate the text to a braille format based on the relevance of the content and learned user preferences. In at least one embodiment, a verification process may be performed to identify whether the physical document is directed to the visually impaired user before translation to braille. In the event the physical document is not directed to the user, a notification may be transmitted to the user and no further processing may be performed. In at least one other embodiment, braille haptic feedback and computer speech may be utilized to understand document content, situational context, and user preferences.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to utilize computer speech and haptic feedback to translate written documents directed to a visually-impaired user to braille and display the translated document to the user over various hardware output formats.

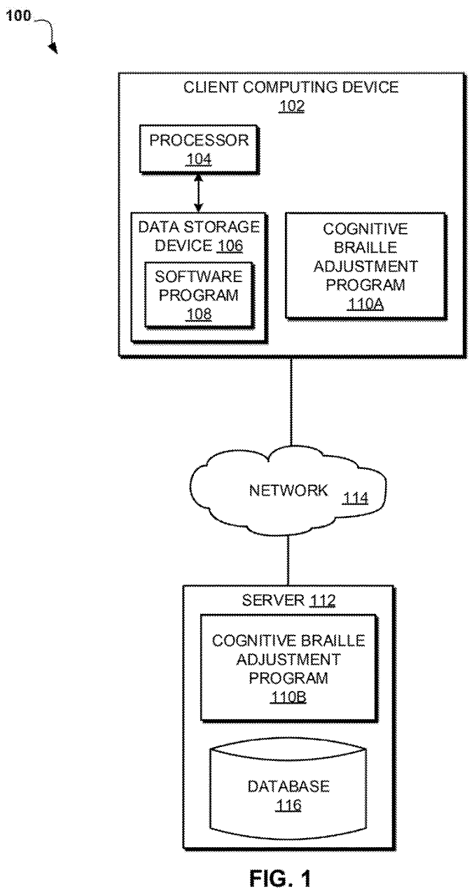

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

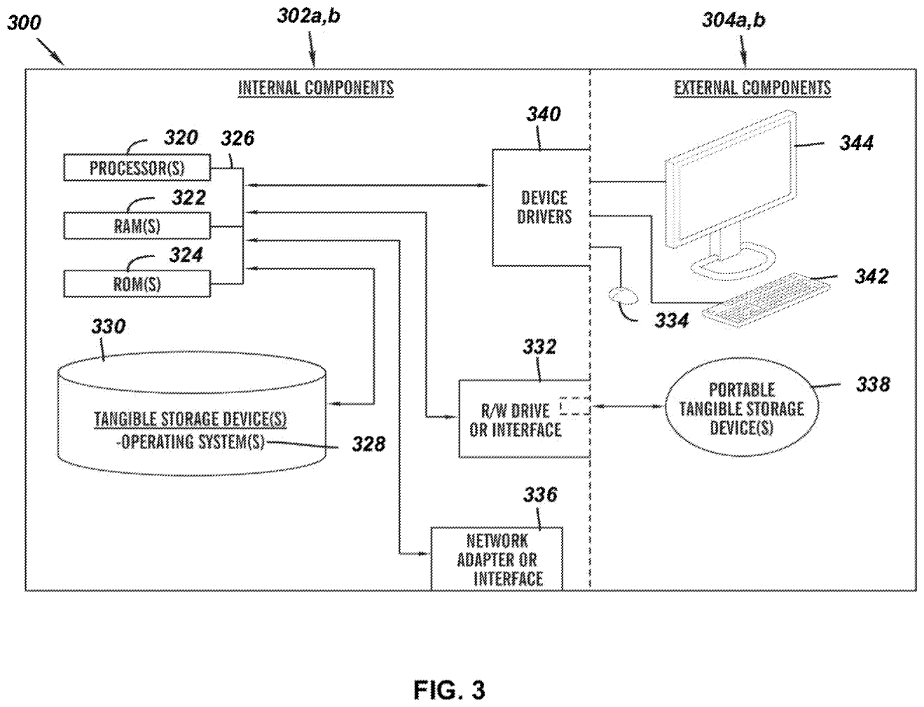

Client computing device 102 may include a processor 104 and a data storage device 106 that is enabled to host and run a software program 108 and a cognitive braille adjustment program 110A and communicate with the server 112 via the communication network 114, in accordance with one embodiment of the invention. Client computing device 102 may be, for example, a wearable smart device, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a cognitive braille adjustment program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

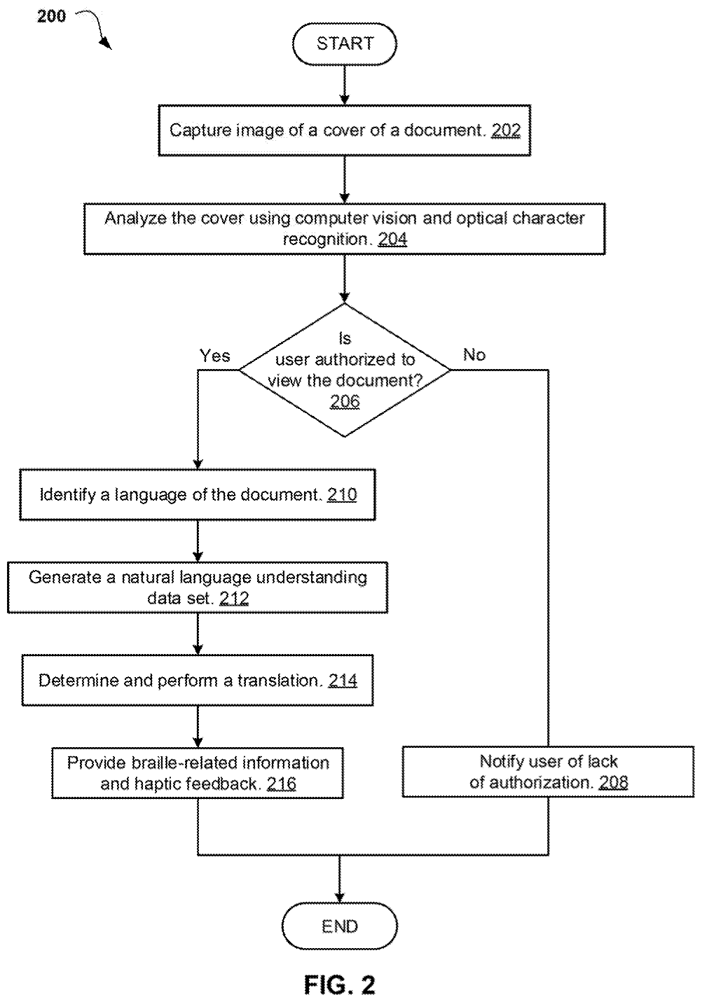

According to the present embodiment, the cognitive braille adjustment program 110A, 110B may be a program capable of verifying a visually-impaired user is authorized to view an addressed paper document, such as an item of postage, identifying a language in which the addressed paper document is written, translating the identified language to braille, and presenting the braille translated language to the user through various software and hardware enablements. The cognitive braille adjustment method is explained in further detail below with respect to FIG. 2.

Referring now to FIG. 2, an operational flowchart illustrating a cognitive braille adjustment process 200 is depicted according to at least one embodiment. At 202, the cognitive braille adjustment program 110A, 110B captures an image of a document cover. When a visually-impaired user receives a physical document, such as a document received through physical mail, the user may wish to engage the cognitive braille adjustment program 110A, 110B. Upon receiving the physical document, the cognitive braille adjustment program 110A, 110B may capture an image of the document cover (e.g., the face of an envelope) through known image capture technologies, such as photographic capture. For example, when a visually-impaired user receives an item in the mail that the user wishes to translate into braille, the user may capture an image of the received item using a user device, such as a smart phone or a tablet. In at least one embodiment, the cognitive braille adjustment program 110A, 110B may utilize haptic feedback to guide the user to successful image capture of the document cover. In at least one other embodiment, the cognitive braille adjustment program 110A, 110B may capture images of one or more sides of a sealed document before a user opens the sealed document in order to perform verification that the user is authorized to open the sealed document. For example, the cognitive braille adjustment program 110A, 110B may capture an image of the front of a sealed mail item and the back of the sealed mail item before it is opened by a user. The verification process under such an embodiment is discussed further in step 206.

Then, at 204, the cognitive braille adjustment program 110A, 110B analyzes the document cover using computer vision and optical character recognition. Upon receiving the captured image, the cognitive braille adjustment program 110A, 110B may perform optical character recognition (OCR) on the received image using computer vision to understand the image orientation, format of the document, and the individual characters present in the text. For example, the cognitive braille adjustment program 110A, 110B may be capable of identifying the recipient name and address on a received item of mail.

Next, at 206, the cognitive braille adjustment program 110A, 110B determines whether the user is authorized to view the document. Upon installation or initial set up of the cognitive braille adjustment program 110A, 110B, the user may be prompted to provide preconfigured personal verification details, such as name and address, to allow the cognitive braille adjustment program 110A, 110B to verify the user is authorized to view received documents. The cognitive braille adjustment program 110A, 110B may store the personal verification details locally in the client computing device 102 or remotely in a repository, such as database 116, in the server 112. Based on a comparison of the personal verification details and the information on the captured image as determined through OCR analysis, the cognitive braille adjustment program 110A, 110B may be capable of determining whether the user if authorized to view the received item. If the cognitive braille adjustment program 110A, 110B determines the user is not authorized to view the received document (step 206, “No” branch), then the cognitive braille adjustment process 200 may proceed to step 208 to notify the user of the lack of authorization. If the cognitive braille adjustment program 110A, 110B determines the user is authorized to view the received document (step 206, “Yes” branch), then the cognitive braille adjustment process 200 may proceed to step 210 to identify the language of the document.

Then, at 208, in response to determining the user is not authorized to view the document, the cognitive braille adjustment program 110A, 110B notifies the user of the lack of authorization. Should the cognitive braille adjustment program 110A, 110B determine that the user is not authorized to view the document based on a comparison of the name and address on the document, as determined by OCR analysis, and the personal verification details, the cognitive braille adjustment program 110A, 110B may transmit a notification to the user to alert the user of the lack of authorization. This notification may be a presented in various forms, such as a display on a graphical user interface that is configured to be legible by the user, braille projections or protrusions on a hardware device enabled to support alternate output formats, or an audible cue where the cognitive braille adjustment program 110A, 110B announces the addressee of the document is not the user.

Next, at 210, in response to determining the user is authorized to view the document, the cognitive braille adjustment program 110A, 110B identifies a language of the document. Upon determining user authorization to view the document, the cognitive braille adjustment program 110A, 110B may proceed to determining a language in which the document is written. In at least one embodiment, the cognitive braille adjustment program 110A, 110B may prompt the user to open a sealed document, such as an addressed letter, upon successful verification of the user and subsequent image capture of the document. For example, once the cognitive braille adjustment program 110A, 110B has determined the user is the addressee of a letter received in postal mail, the cognitive braille adjustment program 110A, 110B may prompt the user to open the letter and capture an image of the letter similar to the image capture performed in step 202. The cognitive braille adjustment program 110A, 110B may utilize an application programming interface (API) for a language detection service, such as IBM Watson® Natural Language Understanding (IBM Watson and all IBM Watson-based trademarks and logos are trademarks or registered trademarks of International Business Machines Corporation and/or its affiliates), which is capable of identifying many different languages.

Then, at 212, the cognitive braille adjustment program 110A, 100B generates a natural language understanding dataset. Upon detection of the language of the text in the document, the cognitive braille adjustment program 110A, 100B may perform backend natural language understanding (NLU) using topic modeling and term frequency-inverse document frequency (tf-idf) framework on the captured image of the document. Information contain on the document may be extracted using latent Dirichlet allocation (LDA) and td-idf and may include entities, keywords, categories, sentiment, emotion, relations, and syntax specific to the identified language. Using preconfigured settings, the cognitive braille adjustment program 110A, 100B may identify specific items of information the user wishes to be left out. Additionally, using td-idf with a context summarizer, the cognitive braille adjustment program 110A, 100B may provide information relevant to the user at a given time T Utilizing an API for NLU, the cognitive braille adjustment program 110A, 100B may capture information on the physical document and generate a model that the user may interact with in various ways as a user would with a voice assistant on a user device. For example, the cognitive braille adjustment program 110A, 100B may allow the user to inquire whether the user has received and mail addressed to him/her, summarize the content of any physical document, or read aloud any information the user is interested in using text-to-speech technology. In at least one embodiment, the natural language understanding dataset may be a structured dataset, such as a JSON, that describes the document.

Next, at 214, the cognitive braille adjustment program 110A, 110B determines and performs a translation. Once the natural language understanding dataset is generated, the cognitive braille adjustment program 110A, 100B may query the dataset against the user's defined preferences to determine the language and encoding of the braille output. The cognitive braille adjustment program 110A, 100B may translate the content of the document into the appropriate type of braille and output as haptic feedback on a user device, such as a touchscreen. In at least one embodiment, the cognitive braille adjustment program 110A, 100B may perform translation to braille in the language in which the user is most comfortable based on historical usage. For example, if a user is French and most comfortable reading French braille, a document in any language may be translated to French braille. The cognitive braille adjustment program 110A, 100B may understand user language preferences over time through machine learning of documents reviewed and read by the user, which language is most spoken by the user as understood through speech-to-text technology, the user's residential region, and other metadata. Additionally, the cognitive braille adjustment program 110A, 100B may enable corresponding natural language processing capabilities, such as document summarization and question and answering systems, in the corresponding braille translation.

In at least one embodiment, the cognitive braille adjustment program 110A, 100B may utilize various language translations based on the contextual setting of the document. For example, the cognitive braille adjustment program 110A, 100B, using NLU, may detect the sender is a friend relation for which the user prefers written English to be translated to English braille. Similarly, the cognitive braille adjustment program 110A, 100B, using NLU, may detect a business communication as the reason for the document for which the user prefers any written language to be translated to Spanish braille.

In at least one other embodiment, the cognitive braille adjustment program 110A, 100B may utilize various encoding levels based on the tone of the written document. For example, the cognitive braille adjustment program 110A, 100B, using NLU, may detect a casual tone for which the user prefers a grade 2 encoding featuring many abbreviations and contractions for increased speed of reading. Similarly, the cognitive braille adjustment program 110A, 100B, using NLU, may detect a formal tone for which the user prefers a grade 1 encoding without any shorthand allowing for increased clarity.

Then, at 216, the cognitive braille adjustment program 110A, 110B provides braille-related information and haptic feedback to the user. Upon performing a translation to braille based on user preferences, the cognitive braille adjustment program 110A, 100B may utilize various hardware units to present the braille translation to the user. The cognitive braille adjustment program 110A, 100B may query user preferences to determine a user preferred output type for the present document under the current setting. For example, if the user is at home, the user may prefer a translation on a primary device. However, if the user is travelling, the user may prefer a translation to be presented on a smaller mobile device. The translation may be presented to the user in one or more formats, such as braille haptic, computer speech, braille three-dimensional (3D) printing, or perturbation generation. In at least one embodiment, the user may provide additional preferences that indicate which format of presentation the user prefers under different circumstances. For example, in one embodiment, the user may prefer that the cognitive braille adjustment program 110A, 100B never infer a translation format and, for each translation, the cognitive braille adjustment program 110A, 100B should prompt the user for the preferred output format via haptic sensors. Similarly, the cognitive braille adjustment program 110A, 100B may be configured to output a haptic translation whenever the cognitive braille adjustment program 110A, 100B determines the user is in transit based on user device accelerometer data. Additionally, if a global positioning system (GPS) determines the user is at home, the cognitive braille adjustment program 110A, 100B may output the translation using computer speech. Furthermore, if the cognitive braille adjustment program 110A, 100B detects compatible 3D hardware is currently connected, the translation maybe presented as a 3D printing or generated perturbations on a hardware device.

It may be appreciated that FIG. 2 provides only an illustration of one implementation and does not imply any limitations with regard to how different embodiments may be implemented. Many modifications to the depicted environments may be made based on design and implementation requirements. In at least one embodiment, when the cognitive braille adjustment program 110A, 100B determines the user is in transit when performing a translation to braille, the cognitive braille adjustment program 110A, 100B may enable user privacy capabilities to ensure protection of sensitive information within the translation that may be readable or viewable by other individuals within a preconfigured distance of the user. For example, a user can enable a custom configured haptic/braille language to protect against another individual from overseeing private information the user may be reviewing. In at least one embodiment, the cognitive braille adjustment program 110A, 100B may detect the presence of an individual near the user using gaze detection, the geolocation of the user in real-time compared to the user's proximity to nearby individuals based on those individuals' geolocation, a combination of the user's travel detection as determined through an accelerometer along with an increase in a proximity to other users, and wearable smart devices enabled to assist visually impaired users sense surrounding environments.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the cognitive braille adjustment program 110A in the client computing device 102 and the cognitive braille adjustment program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the cognitive braille adjustment program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the cognitive braille adjustment program 110A in the client computing device 102 and the cognitive braille adjustment program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the cognitive braille adjustment program 110A in the client computing device 102 and the cognitive braille adjustment program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

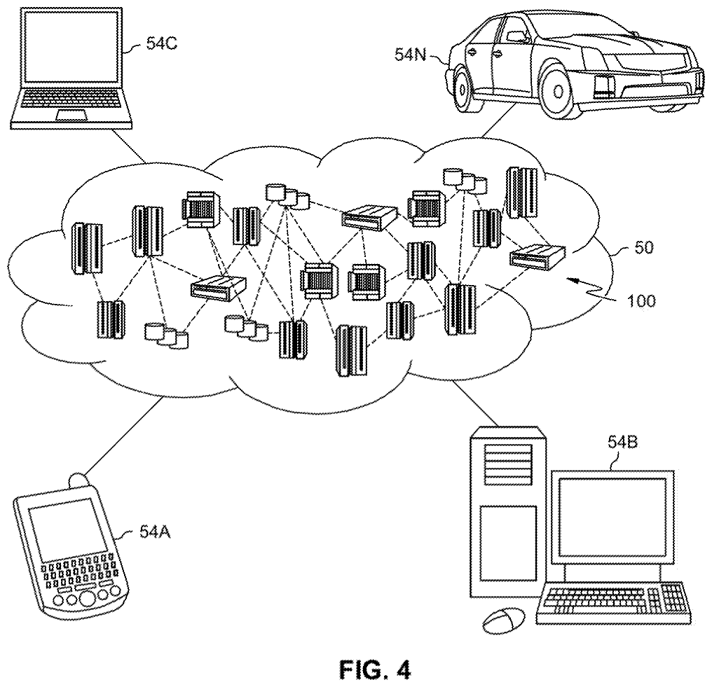

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

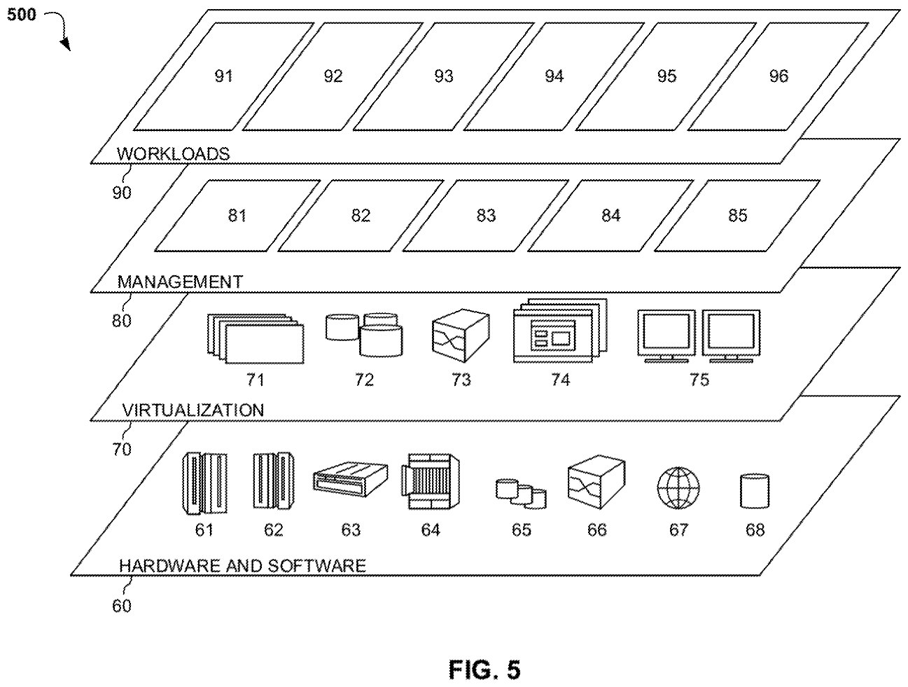

Referring now to FIG. 5, a set of functional abstraction layers 500 provided by cloud computing environment 50 is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cognitive braille adjustment 96. Cognitive braille adjustment 96 may relate to providing dynamic haptic feedback for assisting visually-impaired individuals by allowing a user device to capture a document image, utilizing software and hardware to translate text on the captured document to braille, and present the translated text to the user.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying, by a processor, a language in which text on a document is written;
generating a natural language understanding dataset of the text;
performing a translation of the text to braille using the natural language understanding dataset; and
presenting the translation to a user using one or more associated hardware units.

2. The method of claim 1, further comprising:
capturing an image of a cover of the document;
analyzing the cover using computing vision and optical character recognition; and
determining whether a user is authorized to view the document based on the analysis.

3. The method of claim 2, further comprising:
in response to determining the user is not authorized to view the document, notifying the user of a lack of authorization.

4. The method of claim 2, wherein the determination is further based on a comparison between an addressee and physical address on the cover as determined by the analysis and a name of the user and an address of the user.

5. The method of claim 1, wherein the translation is presented to the user in one or more formats selected from a group consisting of braille haptic, computer speech, braille three-dimensional (3D) printing, or perturbation generation.

6. The method of claim 1, wherein a language of the translation is based on a contextual setting of the document.

7. The method of claim 1, further comprising:
detecting, concurrently to the presenting, an individual within a preconfigured distance of the user; and
enabling one or more user privacy capabilities of the one or more associated hardware units.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a language in which text on a document is written;
generating a natural language understanding dataset of the text;
performing a translation of the text to braille using the natural language understanding dataset; and
presenting the translation to a user using one or more associated hardware units.

9. The computer system of claim 8, further comprising:
capturing an image of a cover of the document;
analyzing the cover using computing vision and optical character recognition; and
determining whether a user is authorized to view the document based on the analysis.

10. The computer system of claim 9, further comprising:
in response to determining the user is not authorized to view the document, notifying the user of a lack of authorization.

11. The computer system of claim 9, wherein the determination is further based on a comparison between an addressee and physical address on the cover as determined by the analysis and a name of the user and an address of the user.

12. The computer system of claim 8, wherein the translation is presented to the user in one or more formats selected from a group consisting of braille haptic, computer speech, braille three-dimensional (3D) printing, or perturbation generation.

13. The computer system of claim 8, wherein a language of the translation is based on a contextual setting of the document.

14. The computer system of claim 8, further comprising:
detecting, concurrently to the presenting, an individual within a preconfigured distance of the user; and
enabling one or more user privacy capabilities of the one or more associated hardware units.

15. A computer program product, the computer program product comprising:
one or more computer-readable tangible storage medium and program instructions stored on at least one of the one or more tangible storage medium, the program instructions executable by a processor capable of performing a method, the method comprising:
identifying a language in which text on a document is written;
generating a natural language understanding dataset of the text;
performing a translation of the text to braille using the natural language understanding dataset; and
presenting the translation to a user using one or more associated hardware units.

16. The computer program product of claim 15, further comprising:
capturing an image of a cover of the document;
analyzing the cover using computing vision and optical character recognition; and
determining whether a user is authorized to view the document based on the analysis.

17. The computer program product of claim 16, further comprising:
in response to determining the user is not authorized to view the document, notifying the user of a lack of authorization.

18. The computer program product of claim 16, wherein the determination is further based on a comparison between an addressee and physical address on the cover as determined by the analysis and a name of the user and an address of the user.

19. The computer program product of claim 15, wherein the translation is presented to the user in one or more formats selected from a group consisting of braille haptic, computer speech, braille three-dimensional (3D) printing, or perturbation generation.

20. The computer program product of claim 15, wherein a language of the translation is based on a contextual setting of the document.
